(19) United States
(12) Patent Application Publication
(10) Pub. No.: US 2003/0039471 A1
(43) Pub. Date: Feb. 27, 2003

(54) Switching compressed video streams

(76) Inventor: Roy T. Hashimoto, Redwood City, CA (US)

Correspondence Address: BEVER HOFFMAN & HARMS, LLP, 2099 GATEWAY PLACE, SUITE 320, SAN JOSE, CA, 951101017

(21) Appl. No.: 09/935,340

(22) Filed: Aug. 21, 2001

(51) Int. Cl. H04N 7/26; H04N 5/781

(52) U.S. Cl. 386/111; 386/125

(57) ABSTRACT

A method for providing fast switching between video tracks is presented. Video packets are defined as each having a size of less than one group of pictures (GOP). These video packets are combined in an interleaved fashion and may be written to a storage medium. When obtaining interleaved video stream elements from a storage medium or from a video stream, each video stream element is read such that the read buffer contains data for a particular frame from each of the tracks. A video stream element may be a packet of size less than one GOP or an interleaved video unit (IlVU) containing one or more GOPs. Because multiple views of the particular frame are resident in the read buffer, a decoder may respond to a command to change video tracks simply by reading a different location in the read buffer, rather than first loading additional track information into the read buffer. The video stream elements are locked into the read buffer when switching between tracks.

### FIELD OF THE INVENTION

The present invention relates to display of video streams from multiple sources. More specifically, the present invention relates to switching display between multiple video stream sources.

### BACKGROUND OF THE INVENTION

A video stream is a stream of video data coming from some source, e.g., a camera or a digital video disk (DVD). In some cases, multiple video streams are produced when simultaneously filming a scene from multiple angles using a set of cameras. Filming a scene from multiple angles allows a viewer to experience that scene from each of the filmed angles, or even from additional angles interpolated between the angles of the set of cameras.

Multiple video streams are useful in a number of different applications. For example, in an immersive video system, multiple video streams are combined into a single, interactive viewer display. In sporting applications, the technique of a player may be honed by watching video stream playback of the performance of the player. For example, to perfect a golf swing, observing the swing from many angles gives additional insight into elements of the golf swing requiring tuning. In a system with multiple cameras filming a scene from different angles, a detail that is obscured from the field of view of one camera may be observable by another camera in the system.

FIG. 1 is a diagram of four cameras filming a scene on a stage 110. A camera 121 is located to the right of stage 110, a camera 122 and a camera 123 are located to the right and down from stage 110, and a camera 124 is located below stage 110. Fields of view 121F-124F are shown for cameras 121-124, respectively. Stage 110 contains a first subject 115 (X) and a second subject 116 (Y). Subjects 115 (X) and 116 (Y) move relative to each other. With the relative positions of subjects 115 (X) and 116 (Y) shown in FIG. 1, subject 115 (X) is partially obscured from the view of cameras 121 and 122 by subject 116 (Y). A viewer watching the video stream from camera 121 may wish to obtain an unobscured view of subject 115 (X). This viewer may obtain this unobscured view by watching the video stream generated by camera 124 rather than the video stream generated by camera 121. In this example, multiple video streams of a single scene are desirable to show detail of the scene unavailable with only one video stream.

Each video stream in a multi-video stream system is called a track. For example, in the four-camera system of FIG. 1 there are four tracks, one video stream (track) from each camera. Video streams comprise a series of frames, wherein each frame is a snapshot in time of a particular scene. Raw (i.e. uncompressed) video streams typically contain a great deal of data, making video data files very large and requiring high bandwidth when transferring these video data files. Video data may be compressed using a variety of conventional compression techniques to lessen bandwidth requirements and video data file sizes. A common technique of video stream compression, called differential compression (or difference-coding), includes both spatial and temporal compression. Spatial compression is compression based on the contents of a single frame of a video stream. Temporal compression is the compression of a series of frames based on the similarities between successive video stream frames. For example, the common data of stationary background objects or the ability to predict the motion of an object throughout successive frames provides a basis for temporal compression. One such method uses a group of pictures (GOP), which consists of a set of successive frames related by the use of temporal compression. GOPs are typically formed of 8-24 frames. For example, a GOP may consist of an I-frame, a number of P-frames, and a number of B-frames. An I-frame is an intra-coded frame, which uses only intra-frame compression and may be decoded without reference to other frames in the video stream. A P-frame is a predictive-coded frame, which may reference preceding I-frames and other preceding P-frames during compression and requires the information from those referenced I-frames and other P-frames during decoding. A B-frame is a bi-directionally-predictive-coded frame, which may reference other (both preceding and succeeding) I-frames and P-frames during compression and requires the information from the referenced I-frames and P-frames during decoding.

FIGS. 2A and 2B are an example of a conventional method of storing multiple video streams (tracks). Multiple compressed video streams are conventionally interleaved in an interleaved video stream in units of one or more GOPs. Each unit comprising the video stream is called an interleaved video unit (ILVU). FIG. 2A depicts three video tracks and their component GOPs. Video track T1 includes an ILVU T1U1, an ILVU T1U2, and an ILVU T1U3. Each ILVU shown in video track T1 includes three GOPs. For example, the first ILVU T1U1 includes a first GOP G1, a second GOP G2, and a third GOP G3. Similarly, video track T2 includes an ILVU T2U1, an ILVU T2U2, and an ILVU T2U3. Each ILVU shown in video track T2 includes three GOPs. Additionally, track T3 includes an ILVU T3U1, an ILVU T3U2, and an ILVU T3U3. Each ILVU shown in video track T3 includes three GOPs. FIG. 2B shows the conventional storage method in which these ILVUs are interleaved. ILVU T1U1, the first ILVU of track T1, is written to storage medium 250 (e.g. a DVD), then ILVU T2U1, the first ILVU of track T2 is written to storage medium 250, and then ILVU T3T1 is written to storage medium 250. ILVU T1U2, the second ILVU of track T1, is then written to storage medium 250. In turn, ILVU T2U2, the second ILVU of track T2, ILVU T3U2, the second ILVU of track T3, and ILVU T1U3, the third ILVU of track T1, are written to storage medium 250. In effect, storage medium 250 stores three GOPs of track T1, then three GOPs of track T2, etc.

FIGS. 3A and 3B are an example of a conventional method of reading conventionally written video tracks. Compressed video streams, which were written to storage medium 250 as described above with respect to FIG. 2B, are read into a read buffer by reading the ILVUs associated with the video track of interest and then skipping over any other interleaved video tracks. Specifically, to read the first video track from storage medium 250, ILVU T1U1 associated with the first video track T1 (FIG. 2A) is read, then the ILVUs associated with video tracks T2 and T3 are skipped. Then ILVU T1U2 of first video track T1 is read, then ILVUs T2U2 and T3U2 are skipped, and so on. FIG. 3B shows the ILVUs associated with video track T1 assembled in read buffer 350. Thus, read buffer 350 contains the ILVUs (and therefore the GOPs) of only first track T1. Specifically, read buffer 350 contains ILVU T1U1 of track T1, then ILVU T1U2 of track T1, then ILVU T1U3 of track T1. The component GOPs, GOP G1, GOP G2, and GOP G3, are shown for ILVU T1U1. A decoder decodes the information in read buffer 350 for a frame buffer for display on, e.g., a television set.

Conventionally, switching between video tracks entails receiving a command to change video tracks, holding the change command until end of the currently displayed ILVU for the current track, and then skipping to the ILVU with the next time-stamp in the new track. The new ILVU from the new track must be read and placed into the read buffer (e.g. read buffer 350 of FIG. 3B). Because the delay between the receipt of the command to switch tracks and the execution of that command can be as much or more than one ILVU, this delay can be considerable and very noticeable to a viewer, and only increases with the number of GOPs in each ILVU. It would be desirable to lessen this delay between track switch command receipt and execution, preferably changing tracks in the frame that is displayed when the command is received. Hence, there is a need for improved video stream interleaving as well as an improved method for switching between video tracks.

### SUMMARY

Accordingly, a method for providing fast switching between video tracks is presented. Each group of pictures (GOP) in the video stream is divided into one or more video packets. In some encoding schemes (e.g. MPEG-1 and MPEG-2), a header for each GOP contains a time-stamp defining the location of the GOP in the video stream. These video packets are combined in an interleaved fashion and may be written to a storage medium. When reading from a video source such as the storage medium or the interleaved video packets, each video packet is read. Because the video packets from all of the tracks are read, the read buffer contains data for a particular frame (i.e. a frame in a GOP having a particular time-stamp) from each of the tracks. The display may be switched between tracks without re-accessing the source for video packets from other tracks. As a result, the decoder decoding each video packet need only access another area of the read buffer, saving video source seek and video source read time during command execution.

In one example, switching between tracks may be accomplished by changing between tracks during playback of the interleaved video streams, such that one frame is displayed from a first track and then the next sequential frame is displayed from another track. In another example, each frame having a similar position within a GOP is displayed when switching to the associated track, providing instantaneous switching of the video stream in a freeze-frame manner. Because the frames of interest have been read into the read buffer, the decoder may simply begin decoding the new frame of the new track from a stored packet in another portion of the read buffer.

To facilitate the combination of video packets into an interleaved video stream, an embodiment of the present invention describes forming each GOP of a video stream into two or more packets. The small size of the packets relative to the GOP size allows a read buffer to contain sufficient video packet information for each track during a read operation to support the fast switching of video tracks.

The present invention will be more fully understood in view of the following description and drawings.

### BRIEF DESCRIPTION OF THE DRAWINGS

FIG. 1 is a diagram of four cameras filming a scene on a stage.

FIGS. 2A and 2B are examples of a conventional method of storing multiple video streams.

FIGS. 3A and 3B are examples of a conventional method of reading conventionally written video tracks.

FIG. 4A is a system for writing interleaved packets according to an embodiment of the present invention.

FIG. 4B is a video stream interleaver in accordance with an embodiment of the system of FIG. 4A.

FIG. 4C is a video stream interleaver in accordance with another embodiment of the system of FIG. 4A.

FIG. 5A is a system for displaying interleaved video streams in accordance with an embodiment of the present invention.

FIG. 5B is an interleaved video stream data source in accordance with an embodiment of the system of FIG. 5A.

FIG. 6A is a segmented read buffer in accordance with an embodiment of the system of FIG. 5A.

FIG. 6B is a ring read buffer in accordance with another embodiment of the system of FIG. 5A.

FIG. 7A is another segmented read buffer in accordance with an embodiment of the system of FIG. 5A.

FIG. 7B is another read buffer in accordance with another embodiment of the system of FIG. 5A.

Similar elements in the Figures are labeled similarly.

### DETAILED DESCRIPTION

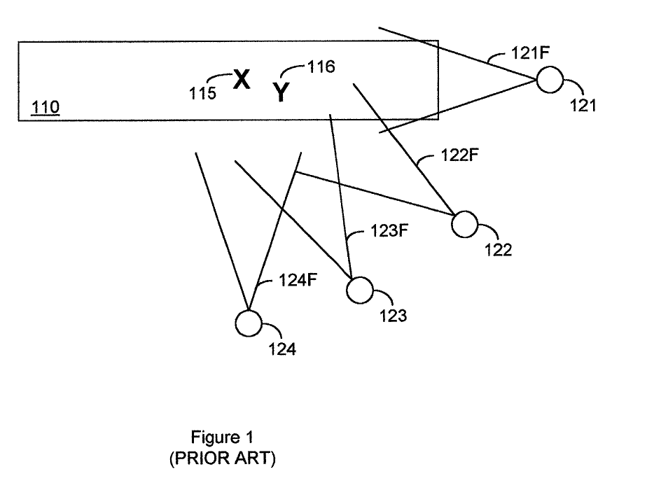

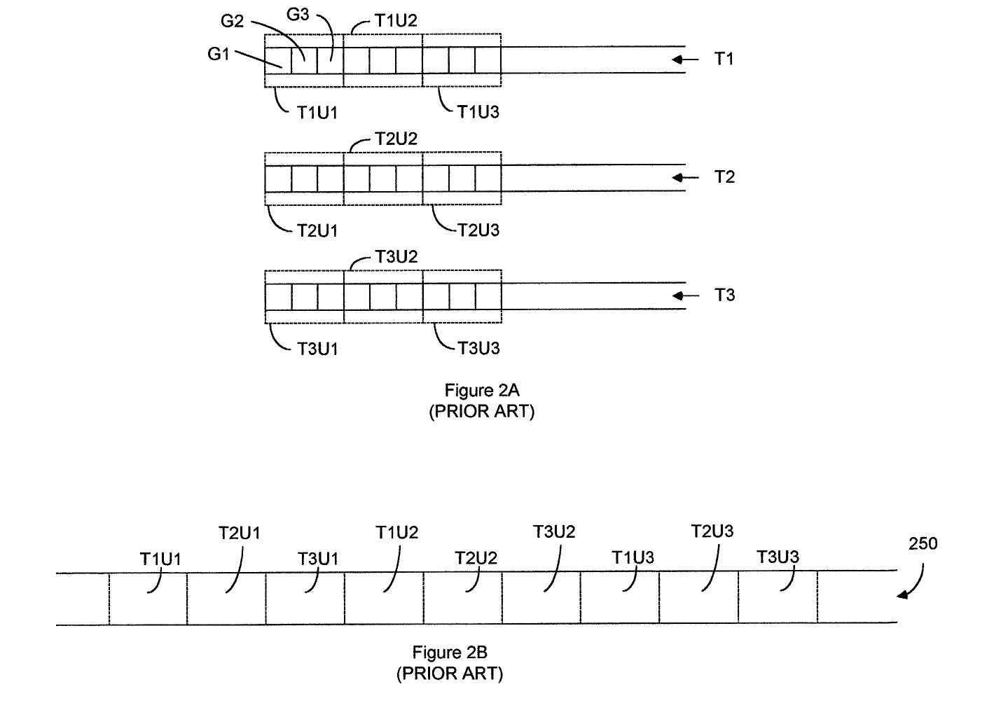

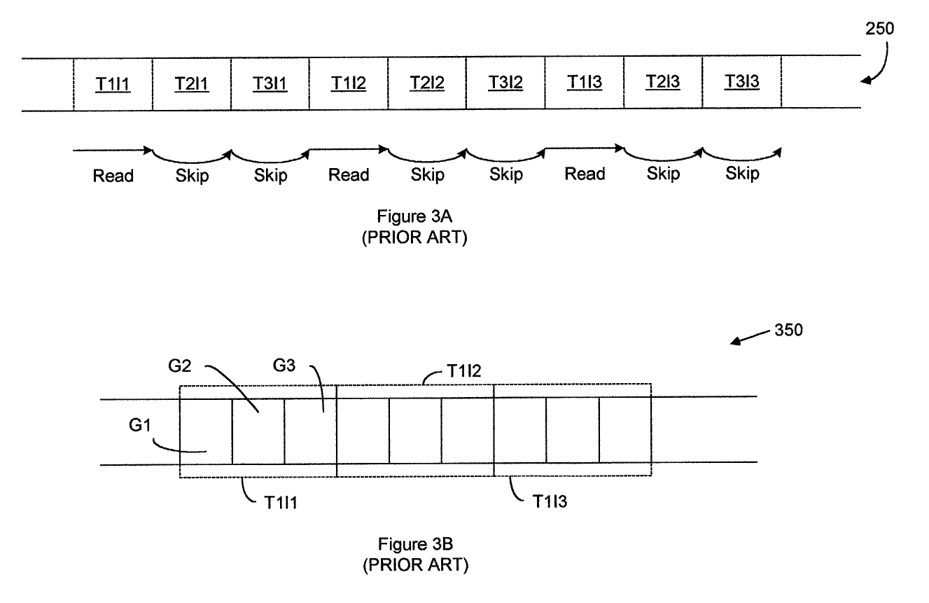

When presented with multiple video tracks, for example, the video streams from a set of cameras filming a scene from multiple locations, it is desirable to have fast access to the information in all of these video tracks. Referring to FIG. 1, a viewer may wish to change the viewed video stream, e.g., to get a different perspective of a scene or to more clearly see something in the scene. It would be desirable to change between one frame in a first track to a frame in a second track without much delay. For example, to change between a first frame on a first track and a frame in the second track occurring one time step later than the frame in the first track. Transferring to a frame one time step later prevents interruption of the displayed video track. Additionally, when viewing a first track, a viewer may wish to pause the display of the scene and examine that particular moment in time from the perspective of each camera. It would be desirable to instantaneously switch between similar frames in multiple video tracks for freeze-frame video track switching to more clearly view a scene at a particular moment in time from multiple angles. To accomplish these goals, a read buffer is filled with the information from each track needed to display frames from multiple video tracks in accordance with one embodiment of the present invention.

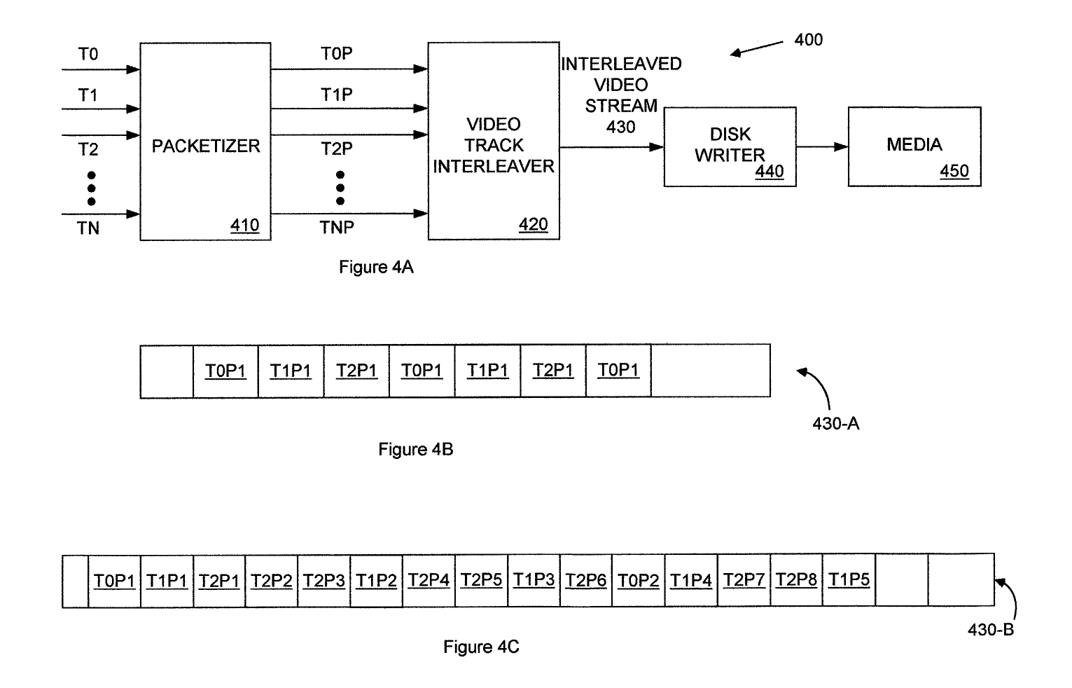

In accordance with the present invention, multiple video tracks are interleaved at a sub-GOP (packet) level and stored. FIG. 4A is a system 400 for writing interleaved packets according to an embodiment of the present invention. A number of video tracks T0, T1, through TN are input to a packetizer 410. Packetizer 410 divides the GOPs of each video track into discrete packets. In one embodiment, these packets have a pre-defined packet size PS. In one variation, pre-defined packet size PS is 2048. The last packet in each GOP may be padded to reach packet size PS. In another variation, each GOP is divided into a pre-determined number of packets (e.g. 14 packets per GOP). As a result, packetizer 410 produces a set of packets for each track. Specifically, a set of packets T0P is generated from track T0, a set of packets T1P is generated from track T1, through a set of packets TNP generated from track TN. These sets of packets are applied to video track interleaver 420. Different GOPs, even GOPs in the same video stream, may have different numbers of associated packets. However, corresponding GOPs in each track (e.g. the first GOP in each track) have the same number of component frames.) In one embodiment, a counter that is reset with the first frame of each GOP is used to track the frame of interest when switching between tracks.

Video track interleaver 420 generates an interleaved video stream 430 by mixing packets from each video track. In one embodiment, video track interleaver 420 investigates each packet to determine which frame the packet references and places groups of packets together that roughly correspond to the same moment in time. Disk writer 440 places the interleaved video stream 430 generated by video track interleaver 420 onto storage medium 450 (e.g., a DVD or a computer hard disk drive).

FIG. 4B is a particular example of the output of video track interleaver 420 of FIG. 4A. In a system 400 having three input video tracks (i.e. N=3), packetizer 410 produces a set of packets T0P for a first track T0, a set of packets T1P for a second track T1, and a set of packets T2P for a third track T2. Set of packets T0P includes a packet T0P1, a packet T0P2, and a packet T0P3. Set of packets T1P includes a packet T1P1 and a packet T1P2. Set of packets T2P includes a packet T2P1 and a packet T2P2. If the compression of the frames defined by packets T0P1, T0P2, T0P3, T1P1, T1P2, T2P1 and T2P2 is roughly similar, the packets may be interleaved in the ratio 1:1:1. That is, video track interleaver 420 places packet T0P1 into an interleaved video stream 430-A, then packet T1P1, then packet T2P1. Video track interleaver 420 then places another packet T0P2 into interleaved video stream 430-A, then packet T1P2, then packet T2P2, then another packet T0P3 from track T0, and so on. In this way, the packets comprising tracks T0, T1, T2 are combined into interleaved video stream 430-A.

As noted above, in some embodiments, video packets are interleaved by video track interleaver 420 such that video packets from GOPs having a similar time-stamp are grouped together in interleaved video stream 430. FIG. 4C is another particular example of the output of video track interleaver 420 of FIG. 4A. In a system similar to the example of FIG. 4B above, the compression of track T1 is three times less than the compression of track T0, and the compression of track T2 is six times less than the compression of track T0. To ensure that related frames from each track T0, T1, and T2 are stored in read buffer simultaneously, video track interleaver 420 investigates each video packet to determine the frame or frames referenced by that packet. A packet at the beginning of a GOP is given a time-stamp of the GOP. Packets in the GOP after the beginning are accorded a time-stamp calculated by the number of frames after the beginning of the GOP. For example, if a packet is N frames after the beginning of a GOP, the time-stamp of that packet is N frame times (e.g. 1.0/29.97 seconds) after the time-stamp of the GOP. In one variation, fractions of a frame in a packet are used for the purpose of computing the packet time-stamp. Video track interleaver 420 then chooses the packet with the earliest time-stamp from all of the tracks to place into interleaved video stream 430-B. If two or more tracks have packets with the same time-stamp, video track interleaver 420 puts them in an arbitrary order. In FIG. 4C, the first GOP of track T1 is highly compressed, and the GOPs of tracks T2 and T3 are successively less compressed. As a result, video packet T0P1 of track T0, video packet T1P1 of Track T1, and video packet T2P1 of track T2 have similar time stamps (for including the beginning of the GOP). However, in this embodiment, video packet T2P2 of track T2 has an earlier time stamp than video packet T1P2, because video packet T1P1 included more frames. Other packets in tracks T0, T1, and T2 are similarly time stamped. As a result, video track interleaver 420 places one video packet of track T1 (packet T0P1), then one video packet of track T1 (packet T1P1), and then three video packets of track T2 (packets T2P1-T2P3) into interleaved video stream 430-B. Video track interleaver 420 then places another one video packet of track T1 (packet T1P2), then two video packets of track T2 (packets T2P4 and T2P5) into interleaved video stream 430-B. In this way, the frame data referenced by the packets of track T2 is near the similarly located frame data of track T1 and of track T0. Thus, video packets corresponding to roughly the same time are located in roughly the same portion of interleaved video stream 430-B. Additionally, because individual GOPs may have different amounts of compression, based on the content of the GOPs, the number of video packets corresponding to each GOP may change from GOP to GOP in the same video stream. As a result, video track interleaver 420 must determine the number of packets needed from each stream during the interleaving process from the investigation of the applied sets of packets.

In the present invention, information is obtained that contains an interleaved video stream (e.g. read from storage medium or obtained from a video stream). This interleaved video stream may comprise video stream packets such as described above with respect to FIGS. 4A, 4B, and 4C or comprise conventional ILVUs. When reading from a storage medium produced with system 400 (FIG. 4A) the size of each video data element that is interleaved is less than the size of one group of pictures (GOP). However, with sufficient read buffer memory as described below, the present invention may be applied to conventional ILVUs (which have a size greater than or equal to the size of one GOP).

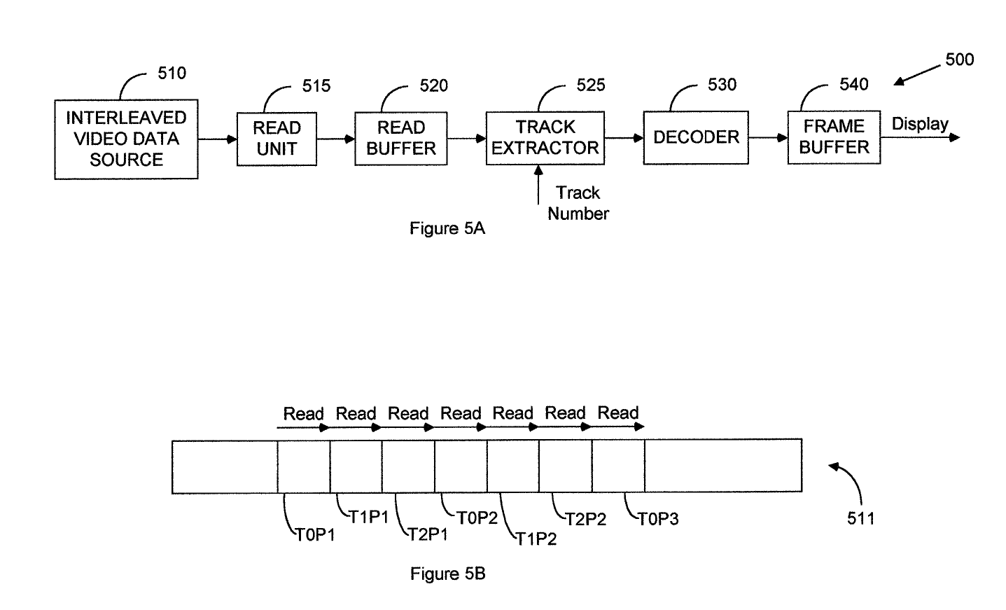

FIG. 5A is a system 500 for displaying interleaved video streams in accordance with an embodiment of the present invention. Read unit 515 reads an interleaved video stream from interleaved video data source 510. Interleaved video data source 510 may be a camera system or a storage medium such as a DVD. Read unit 515 reads each packet or ILVU within the interleaved video stream without skipping over any video data elements. Read unit 515 places the video data elements into read buffer 520. Track extractor 525 receives a track number command and extracts the appropriate packet or ILVU for that track number. Decoder 530 receives the packet or ILVU from track extractor 525 and decodes the video data elements. The appropriate decoded video data elements are placed into frame buffer 540 for display. For example, when switching to a particular frame, track extractor 525 extracts the particular frame and the support frames for the particular frame from read buffer 520 and passes those frames to decoder 530. Because B-frames are not typically the basis for the compression of P-frames, B-frames are typically not decoded by decoder 530 unless they are needed for display. Decoder 530 passes the decoded particular frame to frame buffer 540 to be displayed.

FIG. 5B is an example of an interleaved video stream 511 in accordance with an embodiment the present invention. In this embodiment, interleaved video stream 511 is similar to the interleaved video stream described in FIG. 4B when interleaved video data source 510 stores interleaved video packets. Because read unit 515 reads each packet from interleaved video data source 510, placing each of those packets into the read buffer 520, decoder 530 may instantly respond to a command to switch tracks without waiting for read unit 515 to re-access packets corresponding to other tracks in interleaved video stream 511. Decoder 530 need only access a location within read buffer 520 to access data for a particular frame or the supporting data required to decode that particular frame. In this way the present invention allows not only fast switching between video tracks, but also allows the ability to pause the display of the video stream on a particular frame (i.e. a freeze frame) and examine that moment in time as shown by the different video tracks.

Interleaving using packets is beneficial for a number of reasons. One such reason is that when simultaneously streaming audio tracks, the audio tracks may be switched independently from the video tracks. Maintaining synch between the audio and video tracks is easiest if the bits of the audio are read at approximately the same time as the corresponding bits of video. Since the audio needs to be synched with all of the video tracks, interleaving at a packet level ensures that the audio tracks are proximate to all corresponding video tracks at once in a multiple video track system.

Additionally, because each packet is inspected during the read operation to determine if it is associated with the current video track of interest. When packets are interleaved in groups, it is possible to inspect a number of packets in a row that are not associated with the video track of interest. When packets are individually interleaved, or interleaved in small groups, only a few packets need be inspected before finding a packet associated with the video track of interest. However, an indexing scheme may be added to identify packets without inspection when using large groupings of packets.

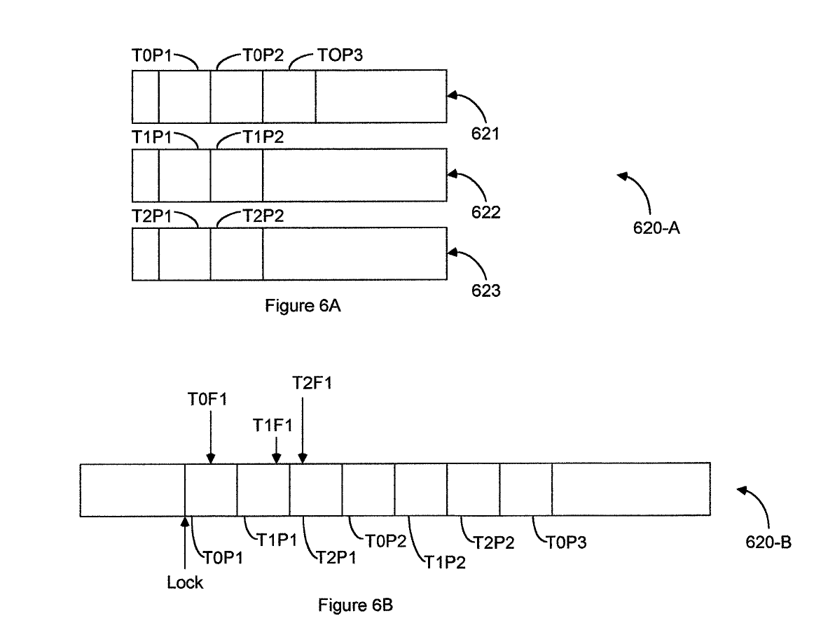

FIG. 6A is a segmented read buffer 620-A shown after reading packets from interleaved video data source 510 of FIG. 5A in accordance with an embodiment of the present invention. Segmented read buffer 620-A includes a sub-buffer 621, a sub-buffer 622, and a sub-buffer 623, with each sub-buffer designated to contain information relating to a particular video track. Referring to FIGS. 5A, 5B and 6A, read unit 515 reads each packet T0P1, T0P2, T0P3, T1P1, T1P2, T2P1, and T2P2 from interleaved video data source 510. Video packets corresponding to the first track T0 (i.e. packets T1P1, T1P2, and T1P3) are stored in the first sub-buffer 621. Video packets corresponding to the second track T1 (i.e. packets T1P1 and T1P2) are stored in the second sub-buffer 622. Video packets corresponding to the third track T2 (i.e. packets T2P1 and T2P2) are stored in the third sub-buffer 623. In this embodiment, decoder 530 chooses one of sub-buffers 621-623 to decode based on the input track number command. Thus, if the track number command indicates that track T2 is to be decoded, decoder 530 reads sub-buffer 623. Because packets from every track are stored in segmented read buffer 620-A, a decoder can change from one track to another track simply by decoding a different sub-buffer.

FIG. 6B is a ring read buffer 620-B shown after reading packets from interleaved video data source 510 of FIG. 5A in accordance with another embodiment of the present invention. Ring read buffer 620-B stores packets in a ring fashion, placing the most recently packet at the location pointed to by a pointer NEWDATA. Thus, when ring read buffer 620-B fills up, the pointer NEWDATA moves back to the left hand side of ring read buffer 620-B to begin refilling ring read buffer 620-B. When a viewer of display system 500 commands a track change, a lock pointer LOCK is placed at the appropriate location in ring read buffer 620-B. For example, an appropriate location may be the beginning of the first packet containing the first I-frame of the GOP having the same time-stamp as the frame upon which the viewer entered the command. A frame T0F1 is marked in packet T0P1. In this example, a viewer commands a track change on a frame T0F1 in track T0 that is part of a GOP marked with time-stamp TIME1. To switch to a corresponding frame in a GOP having time-stamp TIME1 in track T1, decoder 530 (FIG. 5A) moves to the location of the first frame in the GOP also having time-stamp TIME1. Frame T1F1 is the frame in track T1 that corresponds to frame T0F1. Decoder 530 must first decode any frames upon which the compression of frame T1F1 is based. Further, to switch to a frame having a further along in track T1, decoder 530 moves to the location of the start of the GOP containing the new frame and decodes any supporting frames prior to decoding the new frame. Similarly, to switch to a frame in track T2 from another GOP having time-stamp TIME1, decoder 530 moves to the location of the start of a GOP including frame T2F1 also having time-stamp TIME1, decoding any supporting frames before decoding frame T2F1.

While decoder 530 moves through read buffer 620-B, read unit 515 continues reading from interleaved video data source 510 and storing in ring read buffer 620-B. When the pointer NEWDATA encounters the lock pointer LOCK, the pointer NEWDATA stops entering packets into ring read buffer 620-B. In this way, the packet information corresponding to the current frames of interest are locked into read buffer 620-B. Thus, the viewer of display system 500 is able to switch between tracks, decoding from ring read buffer 620-B without having to re-read packets from the interleaved video data source 510 (FIG. 5A). Beneficially, the change in tracks requires only the delay to locate the new frame of the new track in ring read buffer 620-B, decode any supporting frames, and decode the new frame. Additionally, display system 500 is able to continue reading packets into ring read buffer 620-B until full, maximizing the effectiveness of system 500. While a frames of GOPs having a particular time-stamp may be stored in a read buffer by a small set of packets from each track stored in memory, one ILVU from each track is required to access the frames. For this reason, the read buffer memory required when reading packets is much less than the read buffer memory required when reading ILVUs for the same purpose. While small packet sizes (compared to GOP size) avoids wasting space in read buffer 620-B, the present method works as well with large packet sizes.

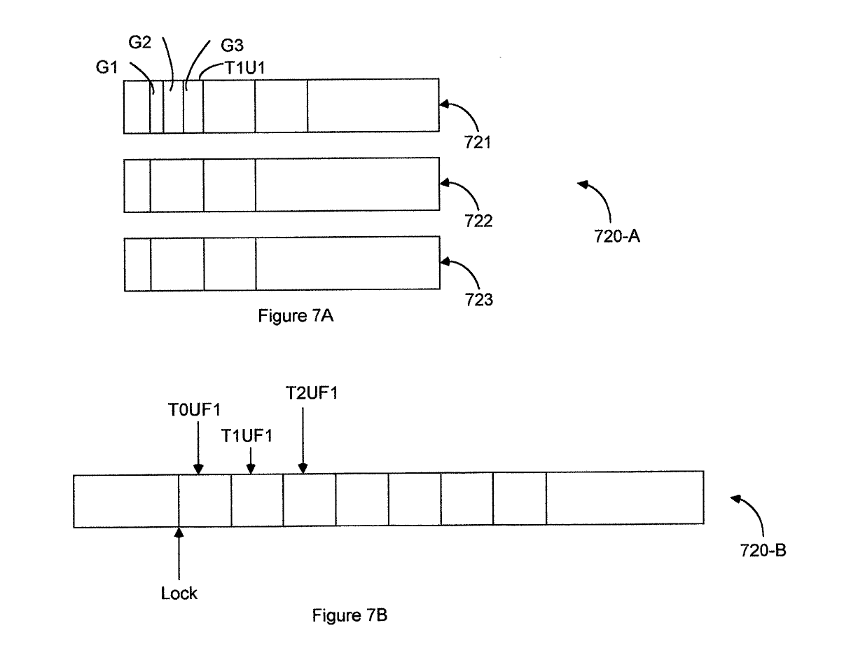

A system of reading interleaved video streams may also be used with conventional ILVUs. FIG. 7A is a segmented read buffer 720-A shown after reading ILVUs from interleaved video data source 510 of FIG. 5A in accordance with an embodiment of the present invention. Segmented read buffer 720-A includes a sub-buffer 721, a sub-buffer 722, and a sub-buffer 723, with each sub-buffer designated to contain information relating to a particular video track. Referring to FIGS. 5A and 7A, read unit 515 reads each ILVU from interleaved video data source 510. ILVUs corresponding to the first track T0 are stored in the first sub-buffer 721. ILVUs corresponding to the second track T1 are stored in the second sub-buffer 722. ILVUs corresponding to the third track T2 are stored in the third sub-buffer 723. In this embodiment, decoder 530 chooses one of sub-buffers 721-723 to decode based on the input track number command. Thus, if the track number command indicates that track T2 is to be decoded, decoder 530 reads sub-buffer 723. Decoder 530 finds the new frame in the new GOP of the new ILVU of the new track and decodes that frame. Because ILVUs from every track are stored in segmented read buffer 720-A, a decoder can change from one track to another track simply by decoding a different sub-buffer.

FIG. 7B is a ring read buffer 720-B shown after reading ILVUs from interleaved video data source 510 of FIG. 5A in accordance with another embodiment of the present invention. Ring read buffer 720-B stores ILVUs in a ring fashion, placing the most recently ILVU at the location pointed to by a pointer NEWDATA. Thus, when ring read buffer 720-B fills up (i.e. fills memory to the right hand side of ring read buffer 720-B), the pointer NEWDATA moves back to the left hand side of ring read buffer 720-B and begins refilling ring read buffer 720-B. When a viewer of display system 500 pauses the display or changes to another track, a lock pointer LOCK is placed at the appropriate location in ring read buffer 720-B. For example, an appropriate location may be the beginning of the first ILVU containing the first I-frame of the GOP including the same time-stamp as the frame at which the viewer entered the command. A frame T0IF1 is marked in the appropriate ILVU of the current track. To switch to a frame another track, decoder 530 (FIG. 5A) moves to the location of the start of another frame, for example frame T1UF1 in track T1 or frame T2UF1 in track T2, also from a GOP having a similar time-stamp. Decoder 530 must first decode any frames upon which the compression of the new frame is based. While decoder 530 moves through read buffer 720-B, read unit 515 continues reading ILVUs from interleaved video data source 510 and storing in ring read buffer 720-B. When the pointer NEWDATA encounters the lock pointer LOCK, the pointer NEWDATA stops entering ILVUs into ring read buffer 720-B. Thus, the viewer of display system 500 is able to switch between tracks, decoding from ring read buffer 720-B without having to re-read ILVUs from the interleaved video data source 510 (FIG. 5A). Thus, the viewer may switch back to the first track, because the ILVU has been protected in memory by the pointer LOCK. Additionally, display system 500 is able to continue reading ILVUs into ring read buffer 720-B until full, maximizing the effectiveness of system 500. The viewer may thus change between different video tracks while viewing the display or pause the display on a particular frame and examine that frame in different video tracks.

In the various embodiments of this invention, novel structures and methods have been described for interleaving video stream packets as well as reading interleaved video streams. By segmenting the GOPs of video tracks into packets, conventional memories can simultaneously store all information required to decode a particular frame of a time-stamped GOP for each video track without re-accessing the interleaved video stream for additional track information. The various embodiments of the structures and methods of this invention that are described above are illustrative only of the principles of this invention and are not intended to limit the scope of the invention to the particular embodiments described. For example, in view of this disclosure, those skilled in the art can define other packet sizes, grouping rules for packets, display methods for switching between video tracks, and so forth, and use these alternative features to create a method or system according to the principles of this invention. Thus, the invention is limited only by the following claims.

1. A method of storing a video stream on a storage medium, comprising:
separating each group of pictures (GOP) of a first compressed video stream into a first plurality of packets;
writing a first packet from the first plurality of packets to the storage medium;
separating each GOP of a second compressed video stream into a second plurality of packets; and
writing a first packet from the second plurality of packets to the storage medium.

2. The method of claim 1, wherein the first packet from the first plurality of packets is written to the storage medium prior to writing the first packet from the second plurality of packets to the storage medium.

3. The method of claim 2, further comprising writing a second packet from the first plurality of packets to the storage medium.

4. The method of claim 3, wherein the second packet from the first plurality of packets is written to the storage medium prior to writing the first packet from the second plurality of packets.

5. The method of claim 3, wherein the first packet from the second plurality of packets is written to the storage medium prior to writing the second packet from the first plurality of packets to the storage medium.

6. The method of claim 5, further comprising writing a second packet from the second plurality of packets to the storage medium.

7. The method of claim 6, wherein the second packet from the second plurality of packets is written to the storage medium prior to writing the second packet from the first plurality of packets.

8. The method of claim 1, wherein the first plurality of packets comprises less than twenty-five packets.

9. The method of claim 1, wherein the first plurality of packets comprises eight packets.

10. A system for writing video data on a storage medium, comprising:
a packetizer for dissembling a first group of pictures (GOP) of a first video track into a first plurality of packets and a second GOP of a second video track into a second plurality of packets;
a video interleaver for combining packets from the first plurality of packets with packets from the second plurality of packets in an interleaved fashion into an interleaved video stream; and
a disk writer for storing the interleaved video stream onto the storage medium.

11. The system of claim 10, wherein the storage medium is a digital video disk (DVD).

12. The system of claim 10, wherein the video interleaver incorporates a first number of packets from the first plurality of packets prior to incorporating a second number of packets from the second plurality of packets.

13. The system of claim 12, wherein the first number is two.

14. The system of claim 13, wherein the second number is three.

15. A storage medium, comprising:
a first packet from a first compressed video stream, the first compressed video stream including a first group of pictures (GOP) and a second GOP, wherein a size of the first packet is less than a size of the first GOP; and
a first packet from a second compressed video stream stored subsequent to the first packet from the first compressed video stream, the second compressed video stream including a third GOP, wherein a size of the first packet from the second compressed video stream is less than a size of the third GOP.

16. The storage medium of claim 15, further comprising
a second packet from the first compressed video stream stored subsequent to the first packet from the second compressed video stream, wherein a size of the second packet from the first compressed video stream is less than a size of the second GOP.

17. The storage medium of claim 15, wherein the first packet from the first compressed video stream is located before the first packet from the second compressed video stream on the storage medium.

18. The storage medium of claim 17, wherein the second packet from the first compressed video stream is located before the first packet from the second compressed video stream on the storage medium.

19. The storage medium of claim 17, wherein the packet from the second compressed video stream is located before the second packet from the first compressed video stream on the storage medium.

20. The storage medium of claim 16, wherein the first packet from the first compressed video stream has the same size as the second packet from the first compressed video stream.

21. The storage medium of claim 15, wherein the first packet from the first compressed video stream has the same size as the first packet from the second compressed video stream.

22. A method of reading a video stream from a video source, comprising:
reading a first video data element of a first video track from the video stream, the first video track having a first group of pictures (GOP); and
reading a second video data element of a second video track stored subsequent to the first packet of the first video track from the video stream, the second video track having a second GOP.

23. The method of claim 22, wherein the first video data element is an interleaved video unit (ILVU) including at least the first GOP of the first video track.

24. The method of claim 22, wherein the first video data element is a packet having a size less than a size of the first GOP of the first video track.

25. The method of claim 22, wherein first video data element and the second video data element are read into a read buffer.

26. The method of claim 25, wherein the read buffer is locked at the first video data element such that the first video data element and the second video data element are stored in the read buffer and such that the read buffer can not overwrite the first video data element and the second video data element until the read buffer is unlocked.

27. The method of claim 25, wherein a location of an I-frame within the first GOP is identified by a first identifier.

28. The method of claim 27, wherein a decoder reading the read buffer accesses the first GOP by accessing a location of the first identifier.

29. The method of claim 27, wherein a location of a P-frame within the first GOP is identified by a second identifier.

30. The method of claim 29, wherein a decoder reading the read buffer avoids accessing a B-frame of the first GOP by accessing only a location of the first identifier and a location of the second identifier.

31. The method of claim 22, wherein a decoder accesses the first video data element of the first video track.

32. The method of claim 31, wherein the decoder switches to access the second video data element of the second video track.

33. The method of claim 32, wherein the decoder skips a B-frame of the second video data element.

34. The method of claim 32, wherein the decoder sends a decoded frame of the second video data element to a frame buffer.

35. The method of claim 22, wherein the video source is a digital video disk (DVD).

36. The method of claim 22, wherein the video source is a camera system.

37. The method of claim 36, wherein the camera system includes a plurality of cameras.
